(19) United States
(12) Patent Application Publication
(10) Pub. No.: US 2025/0144790 A1
(43) Pub. Date: May 8, 2025

(54) Actuation Devices Including Fast and Slow Actuators and Methods for Forming the Same

(71) Applicants: Toyota Motor Engineering & Manufacturing North America, Inc., Plano, TX (US); The University of Texas at Dallas, Richardson, TX (US)

(72) Inventors: Yuyang Song, Ann Arbor, MI (US); Umesh Gandhi, Farmington Hills, MI (US); Yonas Tadesse, Garland, TX (US); Ray H. Baughman, Dallas, TX (US)

(73) Assignees: Toyota Motor Engineering & Manufacturing North America, Inc., Plano, TX (US); Toyota Jidosha Kabushiki Kaisha, Aichi-ken (JP); The University of Texas at Dallas, Richardson, TX (US)

(21) Appl. No.: 18/504,427

(22) Filed: Nov. 8, 2023

(51) Int. Cl. B25J 9/12; B25J 19/00; B25J 19/02; B82Y 15/00

(52) U.S. Cl. CPC B25J 9/12; B25J 19/0054; B25J 19/028; B82Y 15/00

(57) ABSTRACT

Actuation devices and methods for using same are disclosed. The actuation device includes a first actuation layer including a plurality of first actuators operable within a first frequency range, and a second actuation layer provided on the first actuation layer, the second actuation layer including a plurality of second actuators operable within a second frequency range different from the first frequency range.

### TECHNICAL FIELD

The present specification generally relates to actuation devices and, more specifically, actuation devices including a plurality of actuators operable at different frequencies.

### BACKGROUND

Soft robotics have progressed over the past few years, especially in areas of methods of actuation, manufacturing, and sensing. Soft robotics have certain advantages over conventional rigid robotics such as, for example, their ability to perform complex motions with soft materials, high energy absorption, ability to modulate stiffness, and a high degree of freedom. Electric motors and pneumatic actuators have been utilized to develop artificial soft devices. However, these approaches have various drawbacks such as, for example, limitations in terms of size and space, create noise and vibrations, and have complex transmission systems. Pneumatic and/or hydraulic actuators have been utilized that do not exhibit these same drawbacks. However, this approach requires a compressor to force fluid into the actuators to create pressure differences between an ambient environment and an internal pressure. Therefore, it is undesirable to use these two actuation devices in soft robotic systems.

Accordingly, a need exists for improved soft robotic systems that do not exhibit the same drawbacks as pneumatic and hydraulic actuators in existing soft robotics.

### SUMMARY

In one embodiment, an actuation device includes: a first actuation layer including a plurality of first actuators operable within a first frequency range; and a second actuation layer provided on the first actuation layer, the second actuation layer including a plurality of second actuators operable within a second frequency range different from the first frequency range.

In another embodiment, a method includes: forming an actuation device, the actuation device including: a first actuation layer including a plurality of first actuators operable within a first frequency range; and a second actuation layer provided on the first actuation layer, the second actuation layer including a plurality of second actuators operable within a second frequency range different from the first frequency range; and selectively delivering a current to one or more of the first actuators and the second actuators of the actuation device to actuate the actuation device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an embodiment of an actuation device, according to one or more embodiments shown and described herein;

FIG. 2 schematically depicts a partial perspective of the actuation device of FIG. 1 with a protective layer removed, according to one or more embodiments shown and described herein;

FIG. 3 schematically depicts a perspective view of a mold for forming an actuation layer of an actuation device, according to one or more embodiments shown and described herein;

FIG. 4 schematically depicts a perspective view of the mold of FIG. 3 partially filled with silicone, according to one or more embodiments shown and described herein;

FIG. 5 schematically depicts a perspective view of the mold of FIG. 3 partially filled with cured silicone and a pair of first electrodes and a water soluble tube placed on the cured silicone, according to one or more embodiments shown and described herein;

FIG. 6 schematically depicts a perspective view of the mold of FIG. 3 further filled with silicone to cover the pair of first electrodes and the water soluble tube to form a first actuation layer, according to one or more embodiments shown and described herein;

FIG. 7 schematically depicts a perspective view of the first actuation layer of FIG. 6 removed from the mold and placed within a water bath, according to one or more embodiments shown and described herein;

FIG. 8 schematically depicts a perspective view of the first actuation layer of FIG. 7 after the water soluble tubes are dissolved in the water bath, according to one or more embodiments shown and described herein;

FIG. 9 schematically depicts a perspective view of the first actuation layer of FIG. 8 and a second actuation layer provided on the first actuation layer to form an embodiment of an actuation device, according to one or more embodiments shown and described herein;

FIG. 10 schematically depicts a cross-sectional view of the actuation device of FIG. 9 taken along line 10-10 of FIG. 9, according to one or more embodiments shown and described herein;

FIG. 11 schematically depicts a cross-sectional view of a mold including a first elastomer layer and a plurality of first electrodes and a plurality of first water soluble tubes provided on an upper surface of the first elastomer layer, according to one or more embodiments shown and described herein;

FIG. 12 schematically depicts a cross-sectional view of the mold of FIG. 11 and the plurality of first electrodes and the plurality of first water soluble tubes provided within a second elastomer layer, according to one or more embodiments shown and described herein;

FIG. 13 schematically depicts a cross-sectional view of the mold of FIG. 11 and a plurality of second electrodes and a plurality of second water soluble tubes provided on an upper surface of the second elastomer layer, according to one or more embodiments shown and described herein;

FIG. 14 schematically depicts a cross-sectional view of the mold of FIG. 11 and a plurality of second electrodes and a plurality of second water soluble tubes provided on an upper surface of the second elastomer layer, according to one or more embodiments shown and described herein;

FIG. 15 schematically depicts a cross-sectional view of the mold of FIG. 11, the plurality of second electrodes and the plurality of second water soluble tubes provided within a third elastomer layer, a fourth elastomer layer provided on an upper surface of the third elastomer layer, and a plurality of sensors provided on an upper surface of the third elastomer layer, according to one or more embodiments shown and described herein;

FIG. 16 schematically depicts a perspective view of the plurality of sensors provide on the fourth elastomer layer separate from the mold of FIG. 11, according to one or more embodiments shown and described herein;

FIG. 17 schematically depicts a cross-sectional view of the mold of FIG. 11 and the plurality of sensors provided within a fifth elastomer layer to form an embodiment of an actuation device, according to one or more embodiments shown and described herein;

FIG. 18 schematically depicts a cross-sectional view of the actuation device removed from the mold of FIG. 11, according to one or more embodiments shown and described herein; and

FIG. 19 schematically depicts a perspective view of an embodiment of an end effector including a pair of actuation devices, according to one or more embodiments shown and described herein.

### DETAILED DESCRIPTION

Embodiments described herein are directed to flexible actuation devices including a combination of fast actuators and slow actuators to provide additional control over movement and response times of the actuation devices. Generally, the actuation device includes a first actuation layer including a plurality of first actuators operable within a first frequency range, and a second actuation layer provided on the first actuation layer, the second actuation layer including a plurality of second actuators operable within a second frequency range different from the first frequency range. Various embodiments of the actuation devices and methods of operation of the actuation devices are described in more detail herein. Whenever possible, the same reference numerals will be used throughout the drawings to refer to the same or like parts.

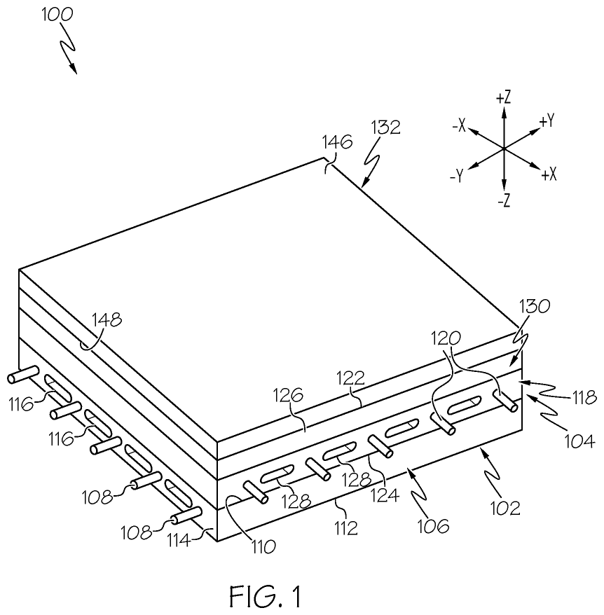

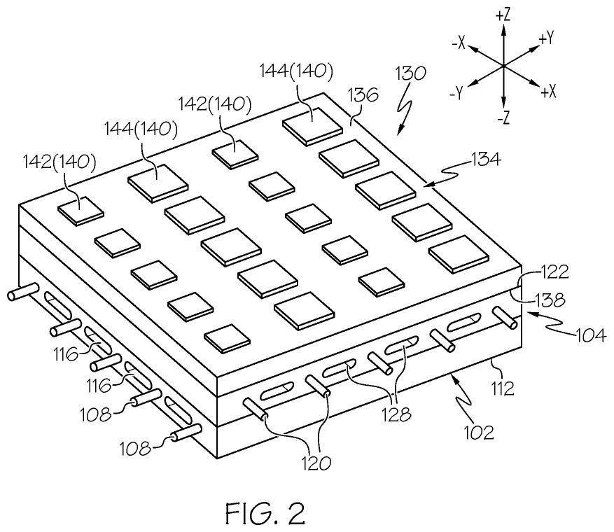

Referring now to FIG. 1, an actuation device 100 is illustrated according to one or more embodiments described herein. The actuation device 100 may generally include a first actuation layer 102 and a second actuation layer 104. As described in more detail herein, the first actuation layer 102 and the second actuation layer 104 may be separately formed and assembled on top of one another. In other embodiments, as described in more detail herein, the first actuation layer 102 and the second actuation layer 104 may be integrally formed as a one-piece, monolithic structure. Additionally, in embodiments, the actuation device 100 may include additional or fewer actuation layers. For example, the actuation device 100 may include only the first actuation layer 102. In other embodiments, the actuation device 100 may include the first actuation layer 102, the second actuation layer 104, and one or more additional layers, as described in more detail herein. However, throughout the ensuing description of the actuation device 100 illustrated in FIGS. 1 and 2, only the first actuation layer 102 and the second actuation layer 104 are depicted.

The first actuation layer 102 includes a first body 106 and a plurality of first actuators 108 extending through the first body 106. The first body 106 has an upper surface 110, a lower surface 112 opposite the upper surface 110, and one or more side walls 114 extending between the upper surface 110 and the lower surface 112 of the first body 106. In embodiments, the first body 106 may be formed from a transparent or at least partially translucent material. As shown, at least one end of the first actuators 108 extends through the side wall 114 of the first body 106 to an outside of the first body 106 such that the first actuators 108 may be communicatively coupled to an external power source to provide voltage to the first actuators 108.

As shown, the first actuators 108 are spaced apart from one another along the X-axis of the coordinate axes depicted in the figures and each first actuator 108 extends along the Y-axis of the coordinate axes. It should be appreciated that, in other embodiments, the first actuators 108 may be spaced apart from one another along the Y-axis of the coordinate axes and each first actuator 108 extends along the X-axis of the coordinate axes. In embodiments, the first actuators 108 may be equidistantly spaced apart from one another or, in other embodiments, spaced apart from one another at various intervals. The first actuators 108 may be shape memory alloy wires or twisted mandrel coiled polymers. The first actuators 108 operate within a first frequency range. In embodiments, the first frequency range has a lower limit of equal to 0.01 Hertz (Hz) +/−10% and an upper limit of 1 Hz +/−10%. In embodiments, the first frequency range has a lower limit of equal to 0.01 Hertz (Hz) +/−20% and an upper limit of 1 Hz +/−20%.

In embodiments, the first actuation layer 102 includes one or more first cooling channels 116 formed within the first body 106. As shown, a first cooling channel 116 is formed within the first body 106 between each pair of adjacent first actuators 108 and terminates at an open end at the side wall 114 of the first body 106. The first cooling channels 116 generally extend along a direction parallel to an extension direction of the first actuators 108. The first cooling channels 116 are fluidly coupled to an external fluid supply to provide a fluid to the first cooling channels 116. The fluid may be utilized to draw heat from the first actuators 108, thereby cooling the first actuators 108 during operation. In embodiments, each of the first cooling channels 116 may be in fluid communication with one another such that only one of the first cooling channels 116 need to directly communicate with the external fluid supply. In other embodiments, each of the first cooling channels 116 individually communicates with the external fluid supply. In embodiments, the first cooling channels 116 are formed from a transparent or at least partially translucent material.

In embodiments, the second actuation layer 104 is provided on the upper surface 110 of the first body 106 of the first actuation layer 102. However, as noted above and discussed in more detail herein, the second actuation layer 104 may be integrally formed with the first actuation layer 102 as a one-piece, monolithic structure.

The second actuation layer 104 has similar structure to the first actuation layer 102. Specifically, the second actuation layer 104 includes a second body 118 and a plurality of second actuators 120 extending through the second body 118. The second body 118 has an upper surface 122, a lower surface 124 opposite the upper surface 122, and one or more side walls 126 extending between the upper surface 122 and the lower surface 124 of the second body 118. Accordingly, as shown, the lower surface 124 of the second body 118 of the second actuation layer 104 is provided on the upper surface 110 of the first body 106 of the first actuation layer 102. In embodiments, the second body 118 may be formed from a transparent or at least partially translucent material. As shown, at least one end of the second actuators 120 extends through the side wall 126 of the second body 118 to an outside of the second body 118 such that the second actuators 120 may be communicatively coupled to an external power source, such as the same external power source in communication with the first actuators 108, to provide voltage to the second actuators 120.

As shown, the second actuators 120 are spaced apart from one another along the Y-axis of the coordinate axes depicted in the figures and each second actuator 120 extends along the X-axis of the coordinate axes. Accordingly, the second actuators 120 extend along a direction perpendicular to a direction along which the first actuators 108 extend. However, it should be appreciated that, in other embodiments, the second actuators 120 may be spaced apart from one another along the X-axis of the coordinate axes and each second actuator 120 extends along the Y-axis of the coordinate axes. Accordingly, in such an embodiment, the second actuators 120 may extend along a direction parallel to a direction along which the first actuators 108 extend. In embodiments, the second actuators 120 may be equidistantly spaced apart from one another or, in other embodiments, spaced apart from one another at various intervals. The second actuators 120 may be carbon nanotube. The second actuators 120 operate within a second frequency range different from the first frequency range. In embodiments, the second frequency range has a lower limit of 1 Hz +/−10% and an upper limit of 10 Hz +/−10%. In embodiments, the second frequency range has a lower limit of 1 Hz +/−20% and an upper limit of 10 Hz +/−20%.

In embodiments, the second actuation layer 104 includes one or more second cooling channels 128 formed within the second body 118. As shown, a second cooling channel 128 is formed within the second body 118 between each pair of adjacent second actuators 120 and terminates at an open end at the side wall 126 of the second body 118. The second cooling channels 128 generally extend along a direction parallel to an extension direction of the second actuators 120. The second cooling channels 128 are fluidly coupled to an external fluid supply, such as the same external fluid supply in communication with the first cooling channels 116, to provide a fluid to the second cooling channels 128. The fluid may be utilized to draw heat from the second actuators 120, thereby cooling the second actuators 120 during operation. In embodiments, each of the second cooling channels 128 may be in fluid communication with one another such that only one of the second cooling channels 128 need to directly communicate with the external fluid supply. In other embodiments, each of the second cooling channels 128 individually communicates with the external fluid supply. In embodiments, the second cooling channels 128 are formed from a transparent or at least partially translucent material.

In embodiments, the actuation device 100 includes a sensor layer 130 provided on either the first actuation layer 102 or the second actuation layer 104, and a protective layer 132 provided on the sensor layer 130. As shown, the sensor layer 130 is provided on the upper surface 122 of the second actuation layer 104. However, it should be appreciated that the sensor layer 130 may alternatively be provided on the lower surface 112 of the first actuation layer 102.

Referring now to FIG. 2, the sensor layer 130 includes a sensor body 134 having an upper surface 136 and a lower surface 138 opposite the upper surface 136, and one or more sensors 140 provided on or within the sensor body 134. In embodiments, the sensor body 134 may be formed from a transparent or at least partially translucent material. As shown, the lower surface 138 of the sensor layer 130 is positioned on the upper surface 122 of the second actuation layer 104. However, as described herein, the lower surface 138 of the sensor layer 130 may alternatively be positioned on the lower surface 112 of the first actuation layer 102. In embodiments, the one or more sensors 140 of the sensor layer 130 includes one or more pressure sensors 142, one or more temperature sensors 144, or a combination thereof. In embodiments, the sensor layer 130 includes a plurality of pressure sensors 142 and a plurality of temperature sensors 144. The pressure sensors 142 may include any suitable sensors for detecting a pressure such as, for example, piezoelectric sensors, strain gauges, capacitive sensors, and the like. The temperature sensors 144 may include any suitable sensors for detecting a temperature such as, for example, negative temperature coefficient (NTC) thermistors, resistance temperature detectors (RTDs), thermocouples, semiconductor-based sensors, and the like.

The pressure sensors 142 and the temperature sensors 144 may be arranged in any suitable arrangement such as, for example, a plurality of rows. Additionally, each individual row may consist of either pressure sensors 142 or temperature sensors 144, as shown in FIG. 2. In other embodiments, each row may include a combination of pressure sensors 142 and temperature sensors 144 in an alternating arrangement. However, it should be appreciated that other configurations of sensors not depicted herein such as, for example, including only pressure sensors 142, only temperature sensors 144, or any other suitable sensor.

Referring again to FIG. 1, the protective layer 132 is shown provided on the sensor layer 130. Specifically, the protective layer 132 has an upper surface 146 and a lower surface 148 opposite the upper surface 146. As shown, the lower surface 148 of the protective layer 132 is provided on the upper surface 136 of the sensor layer 130. Accordingly, the protective layer 132 protects the pressure sensors 142 and the temperature sensors 144 of the sensor layer 130 from external direct contact. In embodiments, the protective layer 132 may be formed from a transparent or at least partially translucent material. Accordingly, fluid flowing through the first cooling channels 116 and the second cooling channels 128, such as a thermochromic fluid, may be visible from an exterior of the actuation device 100. This may be utilized to provide a camouflaging effect to the actuation device 100 by selectively providing a colorized fluid to the first cooling channels 116 and the second cooling channels 128 to control a color of the actuation device 100.

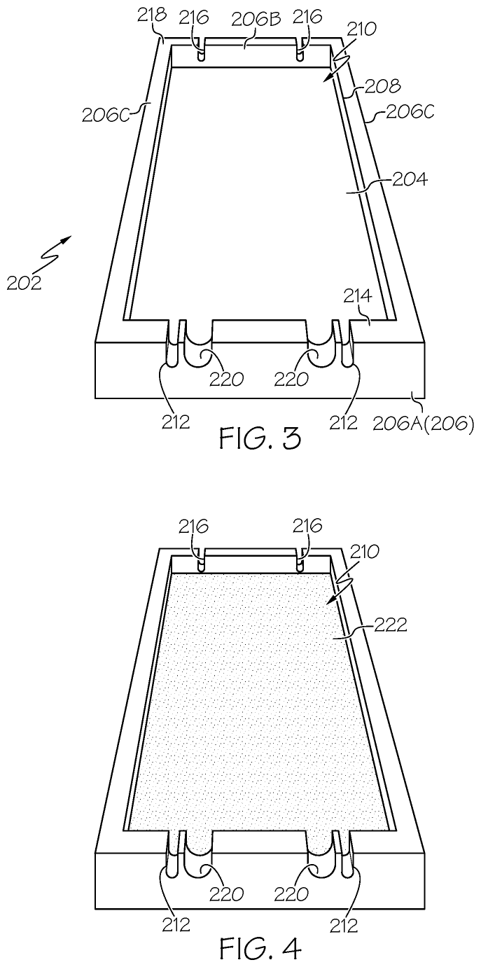

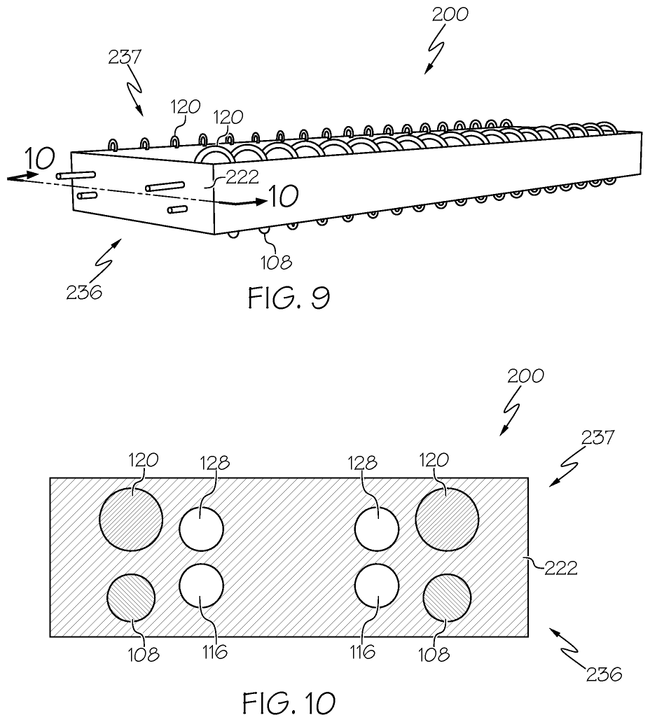

Referring now to FIGS. 3-10, the individual steps of forming an actuation device 200 (FIG. 9) are illustrated. It should be appreciated that the actuation device 200 has similar structure to the actuation device 100 described herein. Therefore, like reference numbers will be used to refer to like parts.

Referring to FIG. 3, a mold 202 is initially provided. In embodiments, the mold 202 is 3D printed from any suitable material such as, for example, polyactic acid (PLA) material. However, the mold 202 may be formed in any suitable manner. The mold 202 includes a bottom wall 204 and one or more side walls 206 defining an open top end 208 and a cavity 210. As shown, the one or more side walls 206 includes a front wall 206A, a rear wall 206B opposite the front wall 206A, a first side wall 206C, and a second side wall 206D, the first side wall 206C and the second side wall 206D extending between the front wall 206A and the rear wall 206B.

In embodiments, a pair of front actuator slots 212 are formed in the front wall 206A of the mold 202. The front actuator slots 212 extend from an upper end 214 of the front wall 206A and terminate prior to reaching the bottom wall 204 of the mold 202. Similarly, a pair of rear actuator slots 216 are formed in the rear wall 206B of the mold 202. The rear actuator slots 216 extend from an upper end 218 of the rear wall 206B and terminate prior to reaching the bottom wall 204 of the mold 202. It should be appreciated that the pair of front actuator slots 212 and the pair of rear actuator slots 216 correspond to the number of actuators to be provided within the particular layer of the actuation device 200. Accordingly, it is understood that the mold 202 may include additional or fewer numbers of front actuator slots 212 and rear actuator slots 216 based on the number of actuators to be utilized.

Additionally, in embodiments, one or more cooling channel slots 220 are formed in the front wall 206A of the mold 202. As shown in FIG. 3, the mold 202 includes a pair of cooling channel slots 220 formed in the front wall 206A of the mold 202. Each cooling channel slot 220 is positioned proximate a respective one of the pair of front actuator slots 212. The cooling channel slots 220 extend from the upper end 214 of the front wall 206A and terminate prior to reaching the bottom wall 204 of the mold 202. It should be appreciated that the cooling channel slots 220 correspond to the number of cooling channels to be formed within the particular layer of the actuation device 200. Accordingly, it is understood that the mold 202 may include additional or fewer numbers of cooling channel slots 220 based on the number of cooling channels to be formed in the actuation device 200 and/or the number of actuators to be utilized.

Referring now to FIG. 4, the cavity 210 of the mold 202 is partially filled with silicone 222. In embodiments, the silicone 222 has a low-shore hardness. In embodiments, the hardness of the silicone 222 has a Shore A durometer range of equal to or less than 20. In embodiments, the hardness of the silicone 222 has a Shore A durometer range of equal to or less than 10. In embodiments, the hardness of the silicone 222 has a Shore A durometer range of equal to or less than 5. The cavity 210 is filled with silicone 222 to a height that is below the front actuator slots 212, the rear actuator slots 216, and the cooling channel slots 220. In embodiments, the height to which the cavity 210 is filled with silicone 222 is 1 millimeter (mm) +/−10%. In embodiments, the height to which the cavity 210 is filled with silicone 222 is 1 mm +/−20%. In embodiments, the height to which the cavity 210 is filled with silicone 222 is 1 mm +/−30%. In embodiments, the height to which the cavity 210 is filled with silicone 222 is 1 mm +/−40%. In embodiments, the height to which the cavity 210 is filled with silicone 222 is 1 mm +/−50%. Once partially filled, the silicone 222 is left to cure. Depending on the specific characteristics of the silicone 222, the curing process may take approximately 2-4 hours. However, the curing time may vary given the size of the mold 202.

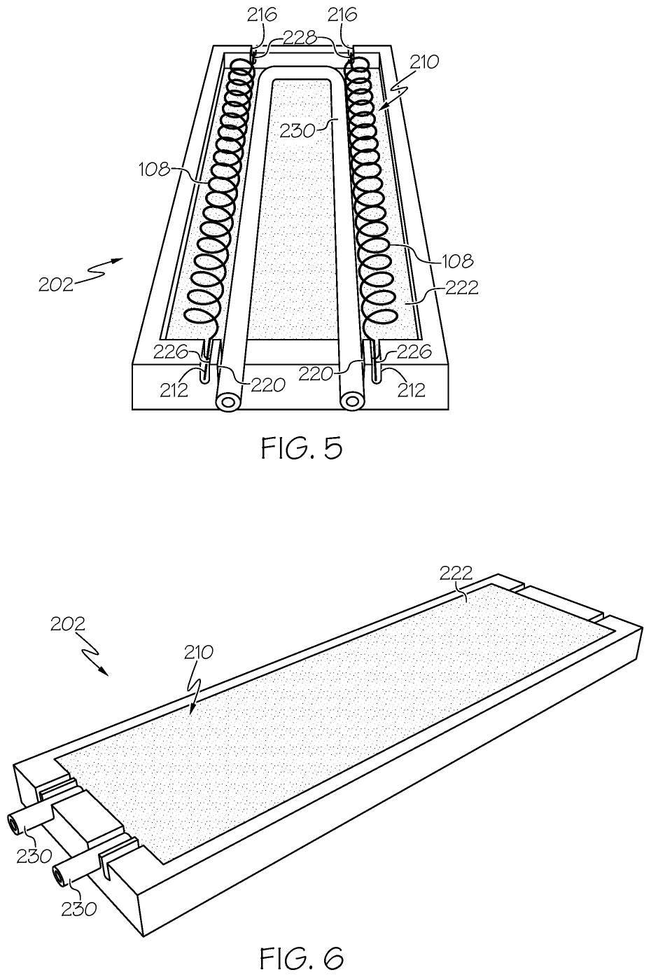

Referring now to FIG. 5, after the silicone 222 cures within the mold 202, a pair of first actuators, such as, for example, the first actuators 108, are positioned within the cavity 210 on top of the silicone 222. The pair of first actuators 108 are positioned such that a front end 226 of the first actuators 108 is received within a respective front actuator slot 212 and a rear end 228 of the first actuators 108 opposite the front end 226 of the first actuators 108 is received within a respective rear actuator slot 216.

Additionally, in embodiments, one or more water soluble tubes 230 are positioned within the cavity 210 on top of the silicone 222 and between the pair of first actuators 108 after the silicone 222 cures within the mold 202. As described in more detail herein, the water soluble tubes 230 are used to form the first cooling channels 116. However, it should be appreciated that in embodiments in which the first cooling channels 116 are not desired, the water soluble tubes 230 are not provided. The water soluble tubes 230 may be formed from polyvinyl alcohol (PVA) tubing. However, the water soluble tubes 230 may be formed from any suitable material. More particularly, the water soluble tubes 230 are positioned such that opposite ends of the water soluble tubes are received within a respective cooling channel slot 220. As shown in FIG. 5, a single water soluble tube having a U-shape is provided. However, as described herein, in embodiments, a pair of individual water soluble tubes 230 may be provided within the mold 202. However, it should be understood that any number of water soluble tubes 230 may be utilized such as one water soluble tube 230 or more than two water soluble tubes 230.

Referring now to FIG. 6, after the first actuators 108, and in embodiments, the water soluble tubes 230, are positioned on the cured silicone 222, additional silicone 222 is poured into the cavity 210 to cover the first actuators 108 and the water soluble tubes 230. The silicone 222 is then left to cure. Again, depending on the specific characteristics of the silicone 222, the curing process may take approximately 2-4 hours. However, the curing time may vary given the size of the mold.

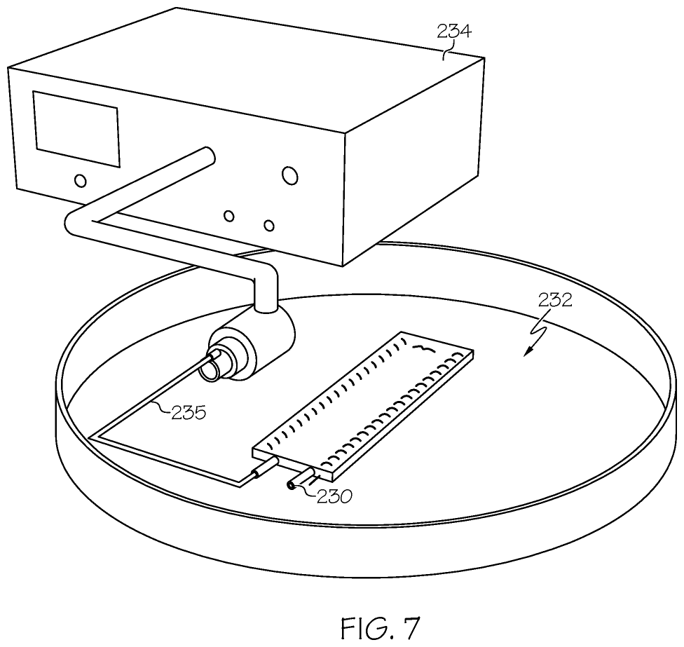

Referring now to FIG. 7, the combination of the first actuators 108 and the water soluble tube 230 embedded within the cured silicone 222 is removed from the mold 202 and placed within a water bath 232 so that water can flow through the water soluble tubes 230. In embodiments, a pump 234 is provided, as shown in FIG. 7, which facilitates pumping water through the water soluble tubes 230 via a conduit 235. The water soluble tubes 230 dissolve within approximately 30 minutes to two hours based on the particular material utilized. In embodiments in which the water soluble tubes 230 are formed from PVA tubing, the PVA tubing dissolves within approximately 60-90 minutes. Once the water soluble tubes 230 are dissolved, the first cooling channels 116 remain. As discussed herein, the first cooling channels 116 may not be provided in certain embodiments. As such, this step may not be necessary in such embodiments.

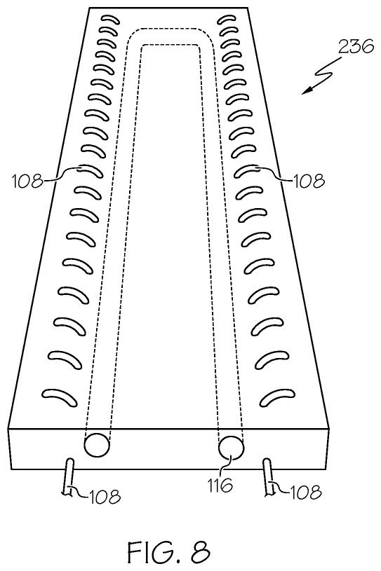

Referring now to FIGS. 8 and 9, a first actuation layer 236 is shown. Specifically, as discussed herein with reference to the first actuation layer 102 (FIG. 1), the first actuation layer 236 includes the first actuators 108 and the first cooling channels 116. In the present embodiment, the first cooling channels 116 have a U-shape and extend along the first actuators 108 to facilitate cooling the first actuators 108. The above steps may be repeated to form a second actuation layer 237, such as, for example, the second actuation layer 104 (FIG. 1) described herein, including the second actuators 120 with or without additional water soluble tubes to form second cooling channels 128.

Thereafter, as shown in FIG. 9, the second actuation layer 237 may be joined to the first actuation layer 236 by applying a thin film of silicone 222 between the second actuation layer 237 and the first actuation layer 236 and allowing the thin film of silicone 222 to cure. The thin film of silicone 222 may take approximately 2-4 hours to cure depending on the thickness of the thin film of silicone 222. In other embodiments, the second actuation layer 237 may be formed on top of the first actuation layer 236 without removing the first actuation layer 236 from the mold 202 (FIG. 6). Specifically, the second actuators 120 and the additional water soluble tube 230 may be provided on top of the first actuation layer 236 with additional silicone 222 prior to removing the first actuation layer 236 from the mold 202. As such, the first actuation layer 236 and the second actuation layer 237 may be simultaneously removed from the mold 202 and pumped with water, via the pump 234 (FIG. 7) to dissolve the water soluble tubes 230 and provide the first cooling channels 116 and the second cooling channels 128. Thus, as described herein, the first actuation layer 236 and the second actuation layer 237 may formed as a monolithic, one-piece component.

Referring now to FIG. 10, a cross-sectional view of the first actuation layer 236 and the second actuation layer 237 is illustrated. Specifically, the first actuation layer 236 is shown as including the pair of first actuators 108 and the first cooling channels 116 arranged in a U-shape. Additionally, the second actuation layer 237 is shown as including the pair of second actuators 120 and the second cooling channels 128 also arranged in a U-shape.

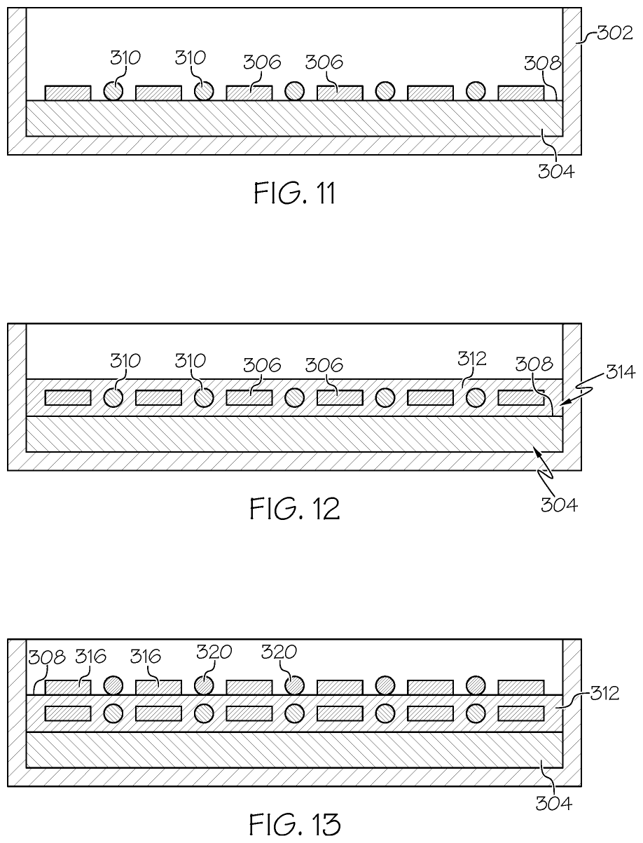

Referring now to FIGS. 11-18, the individual steps of forming an actuation device 300 (FIG. 18) is illustrated. It should be appreciated that the actuation device 300 has similar structure to the actuation devices 100, 200 described herein. Therefore, like reference numbers will be used to refer to like parts.

As shown in FIG. 11, a mold 302 is provided in which a first elastomer layer 304 is provided as a base. The first elastomer layer 304 may include any suitable material such as, for example, silicone. In embodiments, the first elastomer layer 304 is formed from a material having a first Shore hardness. The first elastomer layer 304 is then allowed to cure. Thereafter, a plurality of first water soluble tubes 306, such as the water soluble tubes 230 (FIG. 5) are provided on an upper surface 308 of the first elastomer layer 304 and spaced apart from one another, and a plurality of first actuators 310, such as the first actuators 108 (FIG. 5) operable within a first frequency range are provided on the upper surface 308 of the first elastomer layer 304 and interposed between adjacent water soluble tubes 306.

As described herein with respect to the water soluble tubes 230, the first water soluble tubes 306 may be formed from PVA tubing. However, the first water soluble tubes 306 may be formed from any suitable material. As shown, the first water soluble tubes 306 and the first actuators 310 are arranged in an alternating arrangement. However, it should be understood that other arrangements are within the scope of the present disclosure. For example, fewer first water soluble tubes 306 may be utilized such that no first water soluble tube 306 is provided between certain adjacent first actuators 310. In other embodiments, no first water soluble tubes 306 may be utilized. Although FIG. 11 depicts what appears to be a plurality of first water soluble tubes 306, it should be appreciated that a single first water soluble tube 306 having a serpentine path may be utilized to extend between the first actuators 310.

As described herein with respect to the first actuators 108, the first actuators 310 may be shape memory alloy wires or twisted mandrel coiled polymers. The first actuators 310 operate within a first frequency range. In embodiments, the first frequency range has a lower limit of equal to 0.01 Hertz (Hz) +/−10% and an upper limit of 1 Hz +/−10%. In embodiments, the first frequency range has a lower limit of equal to 0.01 Hertz (Hz) +/−20% and an upper limit of 1 Hz +/−20%.

Thereafter, as shown in FIG. 12, material forming a second elastomer layer 312 is poured onto the upper surface 308 of the first elastomer layer 304 so as to completely submerge the first water soluble tubes 306 and the first actuators 310. The second elastomer layer 312 may include any suitable material such as, for example, silicone. In embodiments, the second elastomer layer 312 is formed from a material having a Shore hardness greater than the Shore hardness of the material forming the first elastomer layer 304. The second elastomer layer 312 is then allowed to cure. The cured second elastomer layer 312 including the first water soluble tubes 306 and the first actuators 310 defines a first actuation layer 314, such as the first actuation layer 102.

Referring now to FIG. 13, after the second elastomer layer 312 has cured, a plurality of second water soluble tubes 316 are provided on an upper surface 318 of the second elastomer layer 312 and spaced apart from one another, and a plurality of second actuators 320 operable within a second frequency range are provided on the upper surface 318 of the second elastomer layer 312 and interposed between adjacent second water soluble tubes 316.

As described herein, the second water soluble tubes 316 may be formed from the same material as the first water soluble tubes 306, e.g., PVA tubing. However, the second water soluble tubes 316 may be formed from any suitable material, such as a different material than that forming the first water soluble tubes 306. As shown, the second water soluble tubes 316 and the second actuators 320 are arranged in an alternating arrangement. However, it should be understood that other arrangements are within the scope of the present disclosure. For example, fewer second water soluble tubes 316 may be utilized such that no second water soluble tube 316 is provided between certain adjacent second actuators 320. In other embodiments, no second water soluble tubes 316 may be utilized. Although FIG. 13 depicts what appears to be a plurality of second water soluble tubes 316, it should be appreciated that a single second water soluble tube 316 having a serpentine path may be utilized to extend between the second actuators 320.

As described herein, the second actuators 320 may be carbon nanotube. The second actuators 320 operate within a second frequency range different from the first frequency range. In embodiments, the second frequency range has a lower limit of 1 Hz +/−10% and an upper limit of 10 Hz +/−10%. In embodiments, the second frequency range has a lower limit of 1 Hz +/−20% and an upper limit of 10 Hz +/−20%.

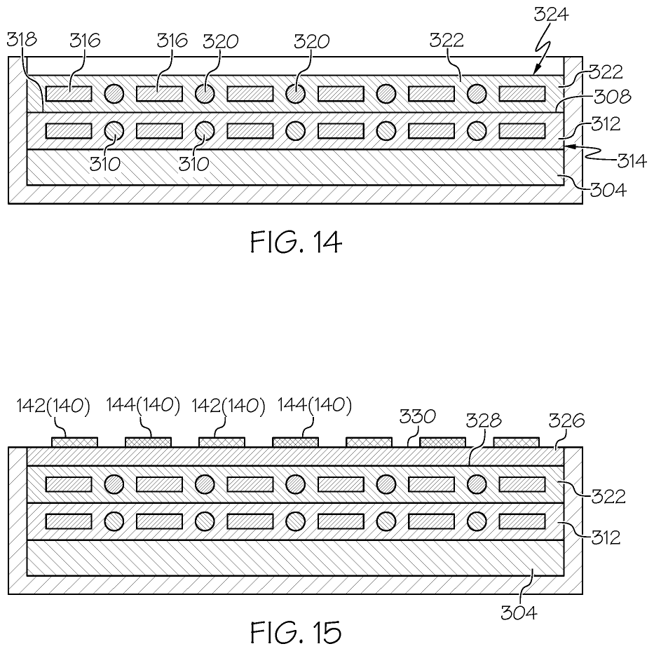

Thereafter, as shown in FIG. 14, material forming a third elastomer layer 322 is poured onto the upper surface 318 of the second elastomer layer 312 so as to completely submerge the second water soluble tubes 316 and the second actuators 320. The third elastomer layer 322 may include any suitable material such as, for example, silicone. In embodiments, the third elastomer layer 322 is formed from a material having a Shore hardness greater than the Shore hardness the first elastomer layer 304. In embodiments, the material forming the third elastomer layer 322 may be the same material forming the second elastomer layer 312. The third elastomer layer 322 is then allowed to cure. The cured third elastomer layer 322 including the second water soluble tubes 316 and the second actuators 320 defines a second actuation layer 324.

Although it is described herein that the first actuation layer 314 located closest to the first elastomer layer 304 includes the first actuators 310, and the second actuation layer 324 located on the upper surface 308 of the first actuation layer 314 opposite the first elastomer layer 304 includes the second actuators 320, it should be appreciated that the arrangement of the first actuation layer 314 and the second actuation layer 324 may be switched. Accordingly, in embodiments, the second actuators 320 may be located in an actuation layer located closer to the first elastomer layer 304 and the first actuators 310 may located in an actuation layer located on a surface of the layer in which the second actuators 320 are provided and opposite the first elastomer layer 304.

Referring now to FIG. 15, material forming a fourth elastomer layer 326 is poured onto an upper surface 328 of the third elastomer layer 322. The fourth elastomer layer 326 may include any suitable material such as, for example, silicone. In embodiments, the fourth elastomer layer 326 is formed from a material having a Shore hardness greater than the Shore hardness of the first elastomer layer 304. In embodiments, the material forming the fourth elastomer layer 326 may be the same material forming the second elastomer layer 312 and the third elastomer layer 322. The fourth elastomer layer 326 is then allowed to cure.

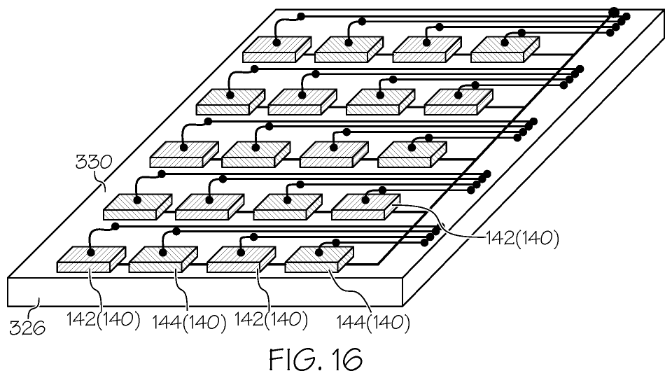

Therefore, referring now to FIGS. 15 and 16, a plurality of sensors, such as the sensors 140, are provided on an upper surface 330 of the fourth elastomer layer 326. As described herein, in embodiments, the plurality of sensors 140 includes one or more pressure sensors 142, one or more temperature sensors 144, or a combination thereof. In embodiments, the sensors include the plurality of pressure sensors 142 and a plurality of temperature sensors 144. As shown, the pressure sensors 142 and the temperature sensors 144 may be arranged in any suitable arrangement such as, for example, a plurality of rows. Additionally, each individual row may consist of a combination of pressure sensors 142 and temperature sensors 144 in an alternating arrangement. However, it should be appreciated that other configurations of sensors not depicted herein such as, for example, including only pressure sensors 142, only temperature sensors 144, or any other suitable sensor.

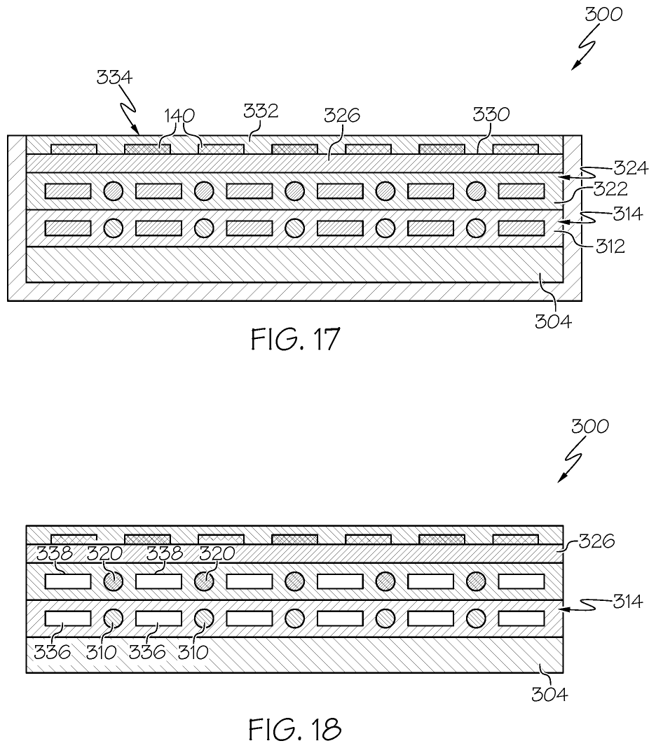

Referring now to FIG. 17, after the sensors 140 are positioned on the upper surface 330 of the fourth elastomer layer 326, material forming a fifth elastomer layer 332 is poured onto the upper surface 330 of the fourth elastomer layer 326 so as to completely submerge the sensors 140. The fifth elastomer layer 332 may include any suitable material such as, for example, silicone. In embodiments, the fifth elastomer layer 332 is formed from a material having a Shore hardness greater than the Shore hardness of the first elastomer layer 304. In embodiments, the material forming the fifth elastomer layer 332 may be the same material forming the second elastomer layer 312, the third elastomer layer 322, and the fourth elastomer layer 326. The fifth elastomer layer 332 is then allowed to cure. The cured fifth elastomer layer 332 including the sensors 140 defines a sensor layer 334. The first elastomer layer 304, the first actuation layer 314, the second actuation layer 324, the fourth elastomer layer 326, and the sensor layer 334 cooperate to form the actuation device 300.

Referring now to FIG. 18, the first water soluble tubes 306 and the second water soluble tubes 316 are dissolved in any suitable manner. For example, the actuation device 300 may be removed from the mold 302 and the actuation device 300 may be placed within a water bath so that water can flow through the first water soluble tubes 306 and the second water soluble tubes 316. The water dissolves the first water soluble tubes 306 and the second water soluble tubes 316 to define first cooling channels 336 and second cooling channels 338, respectively. As described herein, the first cooling channels 336 and the second cooling channels 338 are fluidly coupled to an external fluid supply to provide a fluid to the first cooling channels 336 and the second cooling channels 338. The fluid may be utilized to draw heat from the first actuators 310 and the second actuators 320, thereby cooling the first actuators 310 and the second actuators 320 during operation.

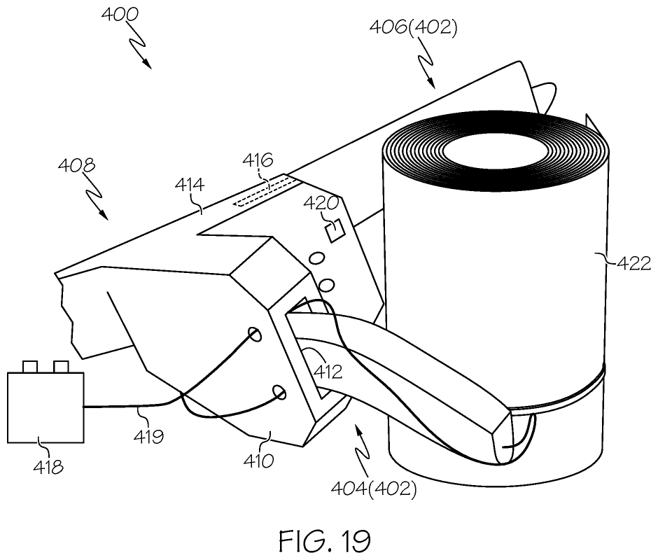

Referring now to FIG. 19, an end effector 400 is depicted including a plurality of actuation devices 402. In embodiments, the actuation devices include a first actuation device 404 and a second actuation device 406. The first actuation device 404 and the second actuation device 406 may include structure similar to the actuation devices 100, 200, 300 discussed herein. As shown in FIG. 19, the end effector 400 includes a receiver 408 for receiving the first actuation device 404 and the second actuation device 406. In embodiments, the receiver 408 includes a first receiver portion 410 having a first opening 412 formed therein, and a second receiver portion 414 having a second opening 416 formed therein. The first actuation device 404 is received within the first opening 412 of the first receiver portion 410, and the second actuation device 406 is received within the second opening 416 of the second receiver portion 414. Although not depicted, a locking mechanism may be utilized to secure the first actuation device 404 and the second actuation device 406 within the first receiver portion 410 and the second receiver portion 414, respectively. The locking mechanism may include, for example, a clip, a magnet, a fastener, and the like. In other embodiments, the first actuation device 404 and the second actuation device 406 may be press fit within the first receiver portion 410 and the second receiver portion 414, respectively. Although the end effector 400 is depicted as including a first receiver portion 410 and a second receiver portion 414 for receiving the first actuation device 404 and the second actuation device 406, respectively, it should be appreciate the end effector 400 may accommodate any number of actuation devices 402. Therefore, the end effector 400 may include any number of receiving portions such as, for example, one receiving portion, three receiving portions, or more than three receiving portions.

In use, one or more terminals 419 extend from a power source 418 to the first actuation device 404 and the second actuation device 406. In embodiments, the power source 418 is a rechargeable direct current power supply. It is to be understood that the power source 418 may be a single power source or battery for providing voltage to the first actuation device 404 and the second actuation device 406. The power source 418 is a device that can receive power at one level (e.g., one voltage, power level, or current) and output power at a second level (e.g., a second voltage, power level, or current). The power source 418 may be operated to selectively provide voltage to the first actuation device 404 and the second actuation device 406, and, more specifically, to the individual actuation layers of the first actuation device 404 and the second actuation device 406 to control the specific flexing of the first actuation device 404 and the second actuation device 406.

In embodiments, one or more sensors 420 may be provided to determine when voltage should be delivered to the first actuation device 404 and the second actuation device 406. For example, the one or more sensors 420 may include a proximity sensor provided on one or both of the first actuation device 404 and the second actuation device 406, an imaging device provided external to the end effector 400, and the like, or a combination thereof. The one or more sensors 420 detect when the end effector 400 is positioned relative to an object 422 such that the object 422 is positioned between the first actuation device 404 and the second actuation device 406. In response to determining that the object 422 is positioned between the first actuation device 404 and the second actuation device 406, the power source 418 supplies voltage to one or more actuation layers of one or both of the first actuation device 404 and the second actuation device 406 to grip the object 422.

From the above, it is to be appreciated that defined herein are flexible actuation layers, flexible actuation devices including one or more flexible actuation layers, end effectors including one or more flexible actuation devices, and methods of operating the same. The actuation devices generally include a first actuation layer including a plurality of first actuators operable within a first frequency range, and a second actuation layer provided on the first actuation layer, the second actuation layer including a plurality of second actuators operable within a second frequency range different from the first frequency range. The first actuators and the second actuators provide a combination of fast actuators and slow actuators that provide increased control over movement and response times of the actuation devices.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An actuation device comprising:
a first actuation layer including a plurality of first actuators operable within a first frequency range; and
a second actuation layer provided on the first actuation layer, the second actuation layer including a plurality of second actuators operable within a second frequency range different from the first frequency range.

2. The actuation device of claim 1, wherein the first actuation layer is integrally formed with the second actuation layer as a one-piece monolithic structure.

3. The actuation device of claim 1, wherein the first frequency range has a lower limit of equal to 0.01 Hz and an upper limit of 1 Hz, and the second frequency range has a lower limit of 1 Hz and an upper limit of 10 Hz.

4. The actuation device of claim 3, wherein each first actuator comprises at least one of shape memory allow wires or twisted and mandrel coiled polymers.

5. The actuation device of claim 3, wherein each second actuator comprises a carbon nanotube.

6. The actuation device of claim 1, wherein a plurality of first cooling channels are provided between adjacent first actuators of the plurality of first actuators.

7. The actuation device of claim 1, wherein a plurality of second cooling channels are provided between adjacent second actuators of the plurality of second actuators.

8. The actuation device of claim 1, further comprising a sensor layer provided on the second actuation layer opposite the first actuation layer.

9. The actuation device of claim 8, wherein the sensor layer comprises at least one pressure sensor and at least one temperature sensor.

10. The actuation device of claim 9, wherein the sensor layer comprises a plurality of pressure sensors and a plurality of temperature sensors arranged in an alternating arrangement.

11. The actuation device of claim 7, further comprising a protective layer provided on a side of the second actuation layer opposite the first actuation layer, wherein the protective layer is at least partially translucent to permit thermochromic fluid flowing through the second cooling channels to be visible external of the actuation device.

12. A method comprising:
forming an actuation device, the actuation device comprising:
a first actuation layer including a plurality of first actuators operable within a first frequency range; and
a second actuation layer provided on the first actuation layer, the second actuation layer including a plurality of second actuators operable within a second frequency range different from the first frequency range; and
selectively delivering a current to one or more of the first actuators and the second actuators of the actuation device to actuate the actuation device.

13. The method of claim 12, wherein the first frequency range has a lower limit of equal to 0.01 Hz and an upper limit of 1 Hz, and the second frequency range has a lower limit of 1 Hz and an upper limit of 10 Hz.

14. The method of claim 13, wherein each first actuator comprises at least one of shape memory allow wires or twisted and mandrel coiled polymers.

15. The method of claim 13, wherein each second actuator comprises a carbon nanotube.

16. The method of claim 12, wherein a plurality of first cooling channels are provided between adjacent first actuators of the plurality of first actuators.

17. The method of claim 12, wherein a plurality of second cooling channels are provided between adjacent second actuators of the plurality of second actuators.

18. The method of claim 12, further comprising a sensor layer provided on the second actuation layer opposite the first actuation layer.

19. The method of claim 18, wherein the sensor layer comprises at least one pressure sensor and at least one temperature sensor.

20. The method of claim 17, further comprising a protective layer provided on a side of the second actuation layer opposite the first actuation layer, wherein the protective layer is at least partially translucent to permit thermochromic fluid flowing through the second cooling channels to be visible external of the actuation device.
